(19) United States
(12) Patent Application Publication
(10) Pub. No.: US 2023/0331960 A1
(43) Pub. Date: Oct. 19, 2023

(54) COMPOSITION, MAGNETIC PARTICLE-CONTAINING CURED SUBSTANCE, AND ELECTRONIC COMPONENT

(71) Applicant: FUJIFILM Corporation, Tokyo (JP)

(72) Inventors: Tatsuo ISHIKAWA, Haibara-gun (JP); Tetsushi Miyata, Haibara-gun (JP)

(73) Assignee: FUJIFILM Corporation, Tokyo (JP)

(21) Appl. No.: 18/340,368

(22) Filed: Jun. 23, 2023

Related U.S. Application Data
(63) Continuation of application No. PCT/JP21/47609, filed on Dec. 22, 2021.

(30) Foreign Application Priority Data
Dec. 25, 2020 (JP) 2020-217521

(51) Int. Cl. C08K 7/18; C08L 63/00; C08K 5/3492; C08K 5/3445; H01F 1/14

(52) U.S. Cl. CPC C08K 7/18; C08L 63/00; C08K 5/3492; C08K 5/3445; H01F 1/14; C08K 2201/005; C08K 2201/003; C08K 2201/014; C08L 2203/20

(57) ABSTRACT

An object of the present invention is to provide a composition that is capable of forming a magnetic particle-containing cured substance having a high magnetic permeability and a low magnetic loss, and has excellent embedding suitability. Another object of the present invention is to provide a magnetic particle-containing cured substance and an electronic component.

The composition according to an embodiment of the present invention is a composition containing magnetic particles that has an Fe atom content of 70% by mass or more and an epoxy resin, in which the magnetic particles have a peak top in a range of 10 to 30 μm in a particle size distribution curve showing a volume-based frequency distribution, and a content of the magnetic particles is 70% to 90% by mass with respect to a total solid content in the composition.

### CROSS-REFERENCE TO RELATED APPLICATIONS

This application is a Continuation of PCT International Application No. PCT/JP2021/047609 filed on Dec. 22, 2021, which claims priority under 35 U.S.C. § 119(a) to Japanese Patent Application No. 2020-217521 filed on Dec. 25, 2020. The above applications are hereby expressly incorporated by reference, in its entirety, into the present application.

### BACKGROUND OF THE INVENTION

### 1. Field of the Invention

The present invention relates to a composition, a magnetic particle-containing cured substance, and an electronic component.

### 2. Description of the Related Art

With the performance upgrade and further miniaturization of electronic devices, the degree of integration of electronic circuits is increasing. As one of the materials for improving the degree of integration, there is a coating-type composition containing magnetic particles. Using such a composition enables a magnetic material to be mounted in any shape, which makes it easier to achieve miniaturization and performance upgrade of electronic devices compared to the conventional method of arranging individual pieces of magnetic materials on a chip.

Examples of the coating-type composition containing magnetic particles include a composition for filling through-holes in a circuit board of an inductor component or the like.

For example, WO2020/105704A discloses, as a composition for filling through-holes, “magnetic paste containing (A) magnetic powder having an average particle diameter of 1 μm or more, (B) epoxy resin, (C) reactive diluent, (D) curing agent, and (E) filler having an average particle diameter less than 1 μm”.

### SUMMARY OF THE INVENTION

As a result of preparing and examining a composition with reference to WO2020/105704A, the inventors of the present invention have found that sometimes a magnetic particle-containing cured substance formed of the composition has a low magnetic permeability. That is, the inventors have found that there is a room for further improvement of the magnetic permeability of the magnetic particle-containing cured substance formed of the composition.

Incidentally, a magnetic particle-containing cured substance formed of a composition containing magnetic particles is also required to have a low magnetic loss.

Furthermore, in view of the use as a composition for filling holes such as via holes and through-holes in a circuit board of an inductor component or the like, the composition containing magnetic particles are required to have excellent embedding suitability.

Therefore, an object of the present invention is to provide a composition that is capable of forming a magnetic particle-containing cured substance having a high magnetic permeability and a low magnetic loss, and has excellent embedding suitability.

Another object of the present invention is to provide a magnetic particle-containing cured substance and an electronic component.

In order to achieve the above objects, the inventors of the present invention conducted intensive studies. As a result, the inventors have found that the objects can be achieved by the following constitutions.

[1] A composition containing magnetic particles that have an Fe atom content of 70% by mass or more and an epoxy resin,
in which the magnetic particles have a peak top in a range of 10 to 30 μm in a particle size distribution curve showing a volume-based frequency distribution, and
a content of the magnetic particles is 70% to 90% by mass with respect to a total solid content in the composition.

[2] The composition described in [1], wherein the magnetic particles are magnetic particles having an Fe atom content of 70% to 95% by mass.

[3] The composition described in [1] or [2], in which the magnetic particles have a plurality of peak tops in the particle size distribution curve showing a volume-based frequency distribution, and
in a case where Dₘᵢₙ represents a particle diameter at a peak top Pₘᵢₙ where the particle diameter is minimized among the plurality of peak tops and Dₘₐₓ represents a particle diameter at a peak top Pₘₐₓ where the particle diameter is maximized among the plurality of peak tops, Dₘₐₓ/Dₘᵢₙ is 2 or more.

[4] The composition described in [3], in which the Dₘₐₓ is in a range of 10 to 30 μm, and the Dₘᵢₙ is in a range of 1 to 9 μm.

[5] The composition described in any one of [1] to [4], further containing a reactive diluent.

[6] The composition described in any one of [1] to [5], further containing a curing agent.

[7] A magnetic particle-containing cured substance formed of the composition described in any one of [1] to [6].

[8] An electronic component including the magnetic particle-containing cured substance described in [7].

[9] The electronic component described in [8], in which the electronic component is used as an inductor.

[10] The electronic component described in [8], in which the electronic component is used as an antenna.

According to an embodiment of the present invention, it is possible to provide a composition that is capable of forming a magnetic particle-containing cured substance having a high magnetic permeability and a low magnetic loss, and has excellent embedding suitability.

Furthermore, according to an embodiment of the present invention, it is possible to provide a magnetic particle-containing cured substance and an electronic component.

### BRIEF DESCRIPTION OF THE DRAWINGS

FIG. 1 is a particle size distribution graph illustrating an example of a frequency distribution curve of specific magnetic particles contained in the composition according to an embodiment of the present invention.

FIG. 2 is a particle size distribution graph illustrating an example of a frequency distribution curve of specific magnetic particles contained in the composition according to an embodiment of the present invention.

### DESCRIPTION OF THE PREFERRED EMBODIMENTS

Hereinafter, the present invention will be specifically described.

The following constituents will be described based on typical embodiments of the present invention in some cases. However, the present invention is not limited to the embodiments.

Regarding the notation of a group (atomic group) in the present specification, unless the gist of the present invention is missed, the notation without the terms “substituted” and “unsubstituted” includes both the group having no substituent and the group having a substituent. For example, “alkyl group” includes not only an alkyl group having no substituent (unsubstituted alkyl group) but also an alkyl group having a substituent (substituted alkyl group). Furthermore, in the present specification, “organic group” refers to a group having at least one carbon atom.

In the present specification, “actinic ray” or “radiation” means, for example, a bright line spectrum of a mercury lamp, a far ultraviolet ray represented by an excimer laser, extreme ultraviolet (EUV light), an X-ray, an electron beam (EB), and the like. In the present specification, “light” means an actinic ray or radiation.

Unless otherwise specified, “exposure” in the present specification means not only the exposure performed using a bright line spectrum of a mercury lamp, a far ultraviolet ray represented by an excimer laser, extreme ultraviolet, an X-ray, EUV light, and the like, but also the drawing performed using particle beams such as an electron beam and an ion beam.

In the present specification, a range described using “to” includes the numerical values listed before and after “to” as a lower limit and an upper limit.

In the present specification, “solid content” of a composition means components that form a cured substance. Therefore, in a case where the composition contains a solvent (such as an organic solvent or water), “solid content” means all the components excluding the solvent. Note that a liquid component is also regarded as a solid content as long as this component forms the cured substance.

In the present specification, unless otherwise specified, “boiling point” means a standard boiling point.

In the present specification, a weight-average molecular weight (Mw) is a polystyrene-equivalent value obtained by a Gel Permeation Chromatography (GPC) method.

In the present specification, as each component, unless otherwise specified, one substance corresponding to each component may be used alone, or two or more substances corresponding to each component may be used in combination. Here, in a case where two or more substances are used in combination as each component, unless otherwise specified, the content of the component means the total content of the substances used in combination.

[Composition]

The composition according to an embodiment of the present invention is a composition containing magnetic particles having an Fe atom content of 70% by mass or more (hereinafter, also called “specific magnetic particles”) and an epoxy resin, in which the specific magnetic particles have a peak top in a range of 10 to 30 μm in a particle size distribution curve showing a volume-based frequency distribution, and a content of the specific magnetic particles is 70% to 90% by mass with respect to a total solid content in the composition.

Through intensive studies by the inventors of the present invention, it has been revealed that the composition having the above constitution can form a magnetic particle-containing cured substance having a high magnetic permeability and a low magnetic loss, and has excellent embedding suitability. In a case where the specific magnetic particles have a peak top in a range of 10 to 30 μm in a particle size distribution curve showing a volume-based frequency distribution, the magnetic particle-containing cured substance formed of the composition has a high magnetic permeability and a low magnetic loss. In addition, in a case where the content of the specific magnetic particles is 70% by mass or more with respect to the total solid content of the composition, the magnetic particle-containing cured substance formed of the composition has a high magnetic permeability. On the other hand, in a case where the content of the specific magnetic particles is 90% by mass or less with respect to the total solid content of the composition, the composition has excellent embedding suitability.

Hereinafter, the higher magnetic permeability of the magnetic particle-containing cured substance formed of the composition, the lower magnetic loss of the magnetic particle-containing cured substance formed of the composition, and/or the better embedding suitability of the composition will be also described as “further improving the effects of the present invention”.

Hereinafter, first, various components contained in the composition will be described.

[Specific Magnetic Particles]

The composition contains magnetic particles (specific magnetic particles) having an Fe atom (hereinafter, also called “iron atom”) content of 70% by mass or more.

Iron atoms may be contained in the magnetic particles, as an alloy containing iron atoms (preferably a magnetic alloy containing iron atoms), an iron oxide (preferably a magnetic iron oxide), an iron nitride (preferably a magnetic iron nitride), or an iron carbide (preferably a magnetic iron carbide).

The content of iron atoms is 70% by mass or more with respect to the total mass of the specific magnetic particles. In a case where the content of iron atoms is 70% by mass or more with respect to the total mass of the specific magnetic particles, the magnetic particle-containing cured substance formed of the composition has an excellent magnetic permeability.

The lower limit of the content of iron atoms with respect to the total mass of the specific magnetic particles is preferably 75% by mass or more, and more preferably 80% by mass or more. In view of further improving acid resistance of the magnetic particle-containing cured substance formed of the composition, the upper limit of the content of iron atoms with respect to the total mass of the specific magnetic particles is preferably 95% by mass or less, more preferably 92% by mass or less, even more preferably 90% by mass or less, and particularly preferably 88% by mass or less.

The specific magnetic particles may contain other metal atoms different from iron atoms.

“Other metal atoms” mentioned herein also include metalloid atoms such as boron, silicon, germanium, arsenic, antimony, and tellurium.

Those other metal atoms may be contained in the magnetic particles, as an alloy containing metal atoms (preferably a magnetic alloy), a metal oxide (preferably a magnetic oxide), a metal nitride (preferably a magnetic nitride), or a metal carbide (preferably a magnetic carbide).

In the specific magnetic particles, the lower limit of the content of metal atoms (total content of iron atoms and other metal atoms) with respect to the total mass of the specific magnetic particles is 70% by mass or more, preferably 75% by mass or more, and more preferably 80% by mass or more. In addition, the upper limit of the content of metal atoms (iron atoms and other metal atoms) with respect to the total mass of the specific magnetic particles is preferably 100% by mass or less, and more preferably 95% by mass or less.

Examples of materials other than iron atoms constituting the specific magnetic particles include Ni, Co, Al, Si, S, Sc, Ti, V, Cu, Y, Mo, Rh, Pd, Ag, Sn, Sb, Te, Ba, Ta, W, Re, Au, Bi, La, Ce, Pr, Nd, P, Zn, Sr, Zr, Mn, Cr, Nb, Pb, Ca, B, C, N, and O.

It is preferable that the specific magnetic particles contain, as materials other than iron atoms, one or more atoms selected from the group consisting of Si, Cr, C, P, Cu, Nb, and B.

The content of each metal atoms in the specific magnetic particles can be identified by high-frequency inductively coupled plasma (ICP) emission spectroscopy.

Specific examples of materials constituting the specific magnetic particles include an Fe—Co-based alloy, an Fe—Ni-based alloy, an Fe—Zr-based alloy, an Fe—Mn-based alloy, an Fe—Si-based alloy, an Fe—Al-based alloy, an Ni—Mo-based alloy, an Fe—Ni—Co-based alloy, an Fe—Si—Cr-based alloy, an Fe—Si—B-based alloy, an Fe—Si—Al-based alloy, an Fe—Si—B—C-based alloy, an Fe—Si—B—Cr-based alloy, an Fe—Si—B—Cr—C-based alloy, an Fe—Co—Si—B-based alloy, an Fe—Si—B—Nb-based alloy, an Fe nanocrystalline alloy, an Fe group amorphous alloy, and a ferrite such as a spinel ferrite (preferably an Ni—Zn-based ferrite or an Mn—Zn-based ferrite) or a hexagonal ferrite (preferably barium ferrite). The above alloys may be amorphous.

Among the above, in view of further improving the magnetic permeability of the magnetic particle-containing cured substance formed of the composition, an alloy is preferable, an Fe group amorphous alloy, an Fe—Si—Cr-based alloy, an Fe nanocrystalline alloy, or an Fe—Ni—Co-based alloy is more preferable, and an Fe group amorphous alloy, an Fe—Si—Cr-based alloy, or an Fe nanocrystalline alloy is even more preferable.

The surface of each of the specific magnetic particles may be provided with a surface layer. In a case where the specific magnetic particles have a surface layer, it is possible to add functions to the specific magnetic particles according to the material of the surface layer.

Examples of the surface layer include an inorganic layer or an organic layer.

As a compound for forming an inorganic layer, in view of making it possible to form a surface layer excellent in at least one of the insulating properties, gas barrier properties, and chemical stability, a metal oxide, a metal nitride, a metal carbide, a phosphoric acid metal salt compound, a boric acid metal salt compound, or a silicic acid compound (for example, a silicic acid ester such as tetraethyl orthosilicate or a silicate such as sodium silicate) is preferable. Specific examples of elements contained in these compounds include Fe, Al, Ca, Mn, Zn, Mg, V, Cr, Y, Ba, Sr, Ge, Zr, Ti, Si, and rare earth elements.

Examples of the material constituting the inorganic layer obtained using the compound for forming an inorganic layer include silicon oxide, germanium oxide, titanium oxide, aluminum oxide, zirconium oxide, magnesium oxide, and the like. The inorganic layer may be a layer that contains two or more of these materials.

Examples of a compound for forming an organic layer include an acrylic monomer. Specific examples of the acrylic monomer include the compounds described in paragraphs “0022” and “0023” of JP2019-067960A.

Examples of the material constituting the organic layer obtained using the compound for forming an organic layer include an acrylic resin.

The thickness of the surface layer is not particularly limited. In view of enabling the surface layer to more effectively function, the thickness of the surface layer is preferably 3 to 1,000 nm.

<Particle Size Distribution>

The specific magnetic particles have a peak top in a range of 10 to 30 μm in a particle size distribution curve showing a volume-based frequency distribution. In the present specification, the particle size distribution curve showing a volume-based frequency distribution is also called “frequency distribution curve”.

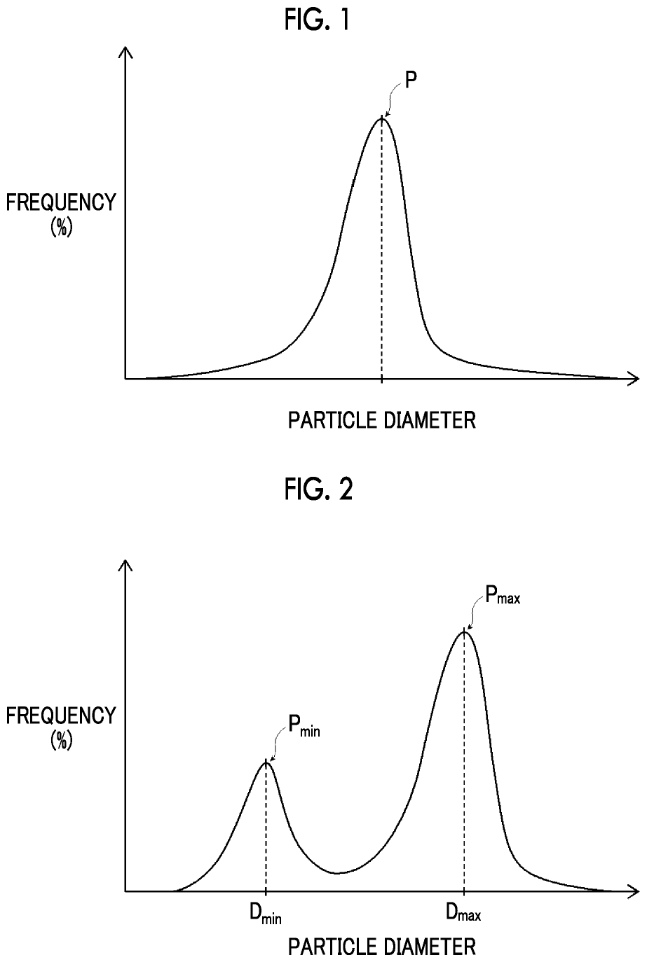

FIGS. 1 and 2 are particle size distribution graphs illustrating an example of a frequency distribution curve of the specific magnetic particles contained in the composition according to an embodiment of the present invention. As shown in FIGS. 1 and 2, the frequency distribution curve is represented by a particle size distribution graph in which particle diameter is plotted on the abscissa and frequency (%) is plotted on the ordinate.

The above frequency distribution curve is obtained by measuring the composition according to an embodiment of the present invention with a laser diffraction/scattering-type particle size distribution analyzer (trade name “LA960N”, manufactured by HORIBA, Ltd.) in a measurement range mode ranging from 0.01 μm to 5,000 μm. For the measurement, as necessary, the composition may be diluted with propylene glycol monomethyl ether acetate (PGMEA) and dispersed with ultrasonic waves for 60 minutes to prepare a dispersion liquid, and the dispersion liquid may be used as a measurement sample.

The peak top in the frequency distribution curve means the maximal point in the frequency distribution curve.

In the example shown in FIG. 1, the frequency distribution curve has one peak top, but the number of peak tops is not limited to this. As shown in FIG. 1, in a case where the frequency distribution curve has one peak top, the peak top (corresponding to P in FIG. 1) appears in a particle diameter range of 10 to 30 μm.

In a case where the frequency distribution curve has one peak top, in view of further reducing the magnetic loss of the magnetic particle-containing cured substance formed of the composition, the peak top is preferably in a particle diameter range of 10 to 20 μm.

In a case where the frequency distribution curve has one peak top, in view of further increasing the magnetic permeability of magnetic particle-containing cured substance formed of the composition, the peak top is preferably in a particle diameter range of 12 to 30 μm.

In a case where the frequency distribution curve has one peak top, in view of further increasing the magnetic permeability and further reducing the magnetic loss of the magnetic particle-containing cured substance formed of the composition, the peak top is preferably in a particle diameter range of 12 to 20 μm.

The frequency distribution curve may have a plurality of peak tops.

In the example shown in FIG. 2, the frequency distribution curve has two peak tops, a peak top Pₘᵢₙ where the particle diameter is minimized and a peak top Pₘₐₓ where the particle diameter is maximized. In a case where the frequency distribution curve has a plurality of peak tops, Dₘᵢₙ represents a particle diameter at the peak top Pₘᵢₙ where the particle diameter is minimized, and Dₘₐₓ represents a particle diameter at the peak top Pₘₐₓ where the particle diameter is maximized, in view of further improving the effects of the present invention, the ratio of Dₘₐₓ to Dₘᵢₙ (Dₘₐₓ/Dₘᵢₙ) is preferably 2 or more. In a case where the ratio (Dₘₐₓ/Dₘᵢₙ) is 2 or more, the gaps formed by the specific magnetic particles having a relatively large particle diameter are filled with the specific magnetic particles having a relatively small particle diameter. As a result, the magnetic loss of the magnetic particle-containing cured substance formed of the composition is further reduced. In view of further improving the effects of the present invention, the ratio (Dₘₐₓ/Dₘᵢₙ) is more preferably 3 or more, and even more preferably 4 or more. In view of further improving the effects of the present invention, the upper limit of the ratio (Dₘₐₓ/Dₘᵢₙ) is preferably 50 or less, more preferably 30 or less, even more preferably 20 or less, and particularly preferably 10 or less.

In addition, in view of further improving the effects of the present invention, Dₘₐₓ is preferably in a range of 10 to 30 μm, and Dₘᵢₙ is preferably in a range of 1 to 9 μm. Especially, Dₘᵢₙ is more preferably in a range of 1 to 5 μm.

For example, by using a plurality of specific magnetic particles having different primary particle diameters and appropriately adjusting the mixing ratio of the particles, it is possible to make the ratio (Dₘₐₓ/Dₘᵢₙ) fall into the above range.

One kind of specific magnetic particles may be used alone, or two or more kinds of specific magnetic particles may be used in combination.

It is preferable that the composition contain, as the specific magnetic particles, at least specific magnetic particles having a volume-based median diameter (D50) of 10 to 30 μm (hereinafter, also called “specific magnetic particles A”).

In a case where all the specific magnetic particles A are divided into two parts by a threshold value which is a particle diameter at which the cumulative volume of the particles is 50%, the total volume of the specific magnetic particles A having a large diameter equals to the total volume of the specific magnetic particles A having a small diameter at a diameter which is the volume-based median diameter (D50) of the specific magnetic particles A.

The volume-based median diameter (D50) of the specific magnetic particles A can be measured with a laser diffraction/scattering-type particle size distribution analyzer (for example, a laser diffraction/scattering-type particle size distribution analyzer LA-960 (model number) manufactured by HORIBA, Ltd.).

In view of further improving the effects of the present invention, the median diameter (D50) of the specific magnetic particles A is preferably 12 to 20 μm.

In a case where the composition contains the specific magnetic particles A as the specific magnetic particles, it is easy to obtain a frequency distribution curve in which a peak top is in a particle diameter range of 10 to 30 μm.

It is preferable that the composition further contain, as the specific magnetic particles, at least specific magnetic particles having a volume-based median diameter (D50) of 1 to 9 μm (hereinafter, also called “specific magnetic particles B”), in addition to the specific magnetic particles A. The definition of the volume-based median diameter (D50) of the specific magnetic particles B and the measuring method thereof are the same as the definition of the volume-based median diameter (D50) of the specific magnetic particles A and the measuring method thereof.

In view of further improving the effects of the present invention, the median diameter (D50) of the specific magnetic particles B is preferably 1 to 5 μm.

In a case where the composition contains the specific magnetic particles A and the specific magnetic particles B as the specific magnetic particles, it is easy to obtain a frequency distribution curve in which Dₘₐₓ is in a range of 10 to 30 μm and Dₘᵢₙ, is in a range of 1 to 9 μm as described above.

In the composition, the content of the specific magnetic particles (total content in a case where the composition contains two or more kinds of specific magnetic particles) is 70% to 90% by mass with respect to the total solid content in the composition. Particularly, in view of further improving the magnetic permeability of the magnetic particle-containing cured substance formed of the composition, the lower limit of the content of the specific magnetic particles is preferably 75% by mass or more, and more preferably 80% by mass or more. In addition, in view of further improving embedding suitability of the composition, the upper limit of the content of the specific magnetic particles is more preferably 88% by mass or less.

In the composition, it is also preferable that the content of the specific magnetic particles be 70% to 90% by mass with respect to the total mass of the composition.

In a case where the specific magnetic particles include the specific magnetic particles A, the lower limit of the content of the specific magnetic particles A with respect to the total mass of the specific magnetic particles is preferably 30% by mass or more, more preferably 40% by mass or more, even more preferably 60% by mass or more, and particularly preferably 80% by mass or more. The upper limit thereof is not particularly limited, and is, for example, 100% by mass or less.

In a case where the specific magnetic particles include the specific magnetic particles B, the upper limit of the content of the specific magnetic particles B with respect to the total mass of the specific magnetic particles is preferably 70% by mass or less, more preferably 60% by mass or less, even more preferably 55% by mass or less, and particularly preferably 50% by mass or less. The lower limit thereof is not particularly limited. For example, the lower limit is 1% by mass or more, preferably 5% by mass or more, more preferably 15% by mass or more, and even more preferably 20% by mass or more.

In a case where the composition contains the specific magnetic particles A and the specific magnetic particles B, and the mixing ratio between the specific magnetic particles A and the specific magnetic particles B is appropriately adjusted, it is easy to obtain a frequency distribution curve in which the ratio (Dₘᵢₙ/Dₘᵢₙ) is 2 or more as described above.

[Epoxy Resin]

The composition contains an epoxy resin.

Examples of the epoxy resin include a bisphenol A-type epoxy resin; a bisphenol F-type epoxy resin; a bisphenol S-type epoxy resin; a bisphenol AF-type epoxy resin; a dicyclopentadiene-type epoxy resin; a trisphenol-type epoxy resin; a phenol novolac-type epoxy resin; a tert-butyl-catechol type epoxy resin; an epoxy resin having a fused ring structure such as a naphthol novolac-type epoxy resin, a naphthalene-type epoxy resin, a naphthol-type epoxy resin, or an anthracene-type epoxy resin; a glycidylamine-type epoxy resin; a glycidyl ester-type epoxy resin; a cresol novolac-type epoxy resin; a biphenyl-type epoxy resin; a linear aliphatic epoxy resin; an epoxy resin having a butadiene structure; an alicyclic epoxy resin; a heterocyclic epoxy resin; a spiro ring-containing epoxy resin; a cyclohexanedimethanol-type epoxy resin; a trimethylol-type epoxy resin; a tetraphenylethane-type epoxy resin, and the like.

The epoxy resin is preferably one or more resins selected from a bisphenol A-type epoxy resin and a bisphenol F-type epoxy resin.

It is preferable that the epoxy resin include an epoxy resin having two or more epoxy groups in one molecule.

In addition, the epoxy resin preferably has an aromatic structure, and more preferably has at least one aromatic structure in a case where two or more epoxy resins are used. The aromatic structure is a chemical structure generally defined as aromatic, and also includes a polycyclic aromatic and an aromatic heterocyclic ring.

The epoxy resin includes an epoxy resin that is a liquid at a temperature of 25° C. (hereinafter, also called “liquid epoxy resin”) and an epoxy resin that is a solid at a temperature of 25° C. (hereinafter, also called “solid epoxy resin”). The composition may contain either a liquid epoxy resin or a solid epoxy resin as the epoxy resin. In view of further improving the effects of the present invention, it is preferable that the composition contain only a liquid epoxy resin.

As the liquid epoxy resin, a bisphenol A-type epoxy resin, a bisphenol F-type epoxy resin, a bisphenol AF-type epoxy resin, a naphthalene-type epoxy resin, a glycidyl ester-type epoxy resin, a glycidylamine-type epoxy resin, a phenol novolac-type epoxy resin, an alicyclic epoxy resin having an ester skeleton, a cyclohexanedimethanol-type epoxy resin, or an epoxy resin having a butadiene structure is preferable, and a glycidylamine-type epoxy resin, a bisphenol A-type epoxy resin, a bisphenol F-type epoxy resin, or a bisphenol AF-type epoxy resin is more preferable.

Specific examples of the liquid epoxy resin include “HP4032”, “HP4032D”, and “HP4032SS” (naphthalene-type epoxy resin) manufactured by DIC Corporation; “828US” and “jER828EL” (bisphenol A-type epoxy resin) “jER807” (bisphenol F-type epoxy resin), and “jER152” (phenol novolac-type epoxy resin) manufactured by Mitsubishi Chemical Corporation; “630” and “630LSD” (glycidylamine-type epoxy resin) manufactured by Mitsubishi Chemical Corporation; “ZX-1059” (mixture of A bisphenol A-type epoxy resin and A bisphenol F-type epoxy resin) manufactured by NIPPON STEEL Chemical & Material Co., Ltd.; “EX-721” (glycidyl ester-type epoxy resin) manufactured by Nagase ChemteX Corporation; “PB-3600” (epoxy resin having a butadiene structure) and “EHPE 3150” (alicyclic epoxy resin) manufactured by Daicel Corporation, and the like.

Examples of the solid epoxy resin include a naphthalene-type tetrafunctional epoxy resin, a cresol novolac-type epoxy resin, a dicyclopentadiene-type epoxy resin, a trisphenol-type epoxy resin, a naphthol-type epoxy resin, a biphenyl-type epoxy resin, a naphthylene ether-type epoxy resin, an anthracene-type epoxy resin, a bisphenol A-type epoxy resin, and a tetraphenylethane-type epoxy resin.

Specific examples of the solid epoxy resin include “HP4032H” (naphthalene-type epoxy resin), “HP-4700” and “HP-4710” (naphthalene-type tetrafunctional epoxy resin), “N-690” and “N-695” (cresol novolac-type epoxy resin), “HP-7200”, “HP-7200HH”, and “HP-7200H” (dicyclopentadiene-type epoxy resin), “EXA-7311”, “EXA-7311-G3”, “EXA-7311-G4”, “EXA-7311-G4S”, and “HP6000” (naphthylene ether-type epoxy resin) manufactured by DIC Corporation; “EPPN-502H” (Trisphenol-type epoxy resin), “NC7000L” (naphthol novolac-type epoxy resin), “NC3000H”, “NC3000”, “NC3000L”, and “NC3100” (biphenyl-type epoxy resin) manufactured by Nippon Kayaku Co., Ltd.; “ESN475V” (naphthalene-type epoxy resin) and “ESN485” (naphthol novolac-type epoxy resin) manufactured by NIPPON STEEL Chemical & Material Co., Ltd.; “YX4000h” and “YL6121” (biphenyl-type epoxy resin), “YX4000HK” (bixylenol-type epoxy resin), and “YX8800” (anthracene-type epoxy resin) manufactured by Mitsubishi Chemical Corporation; “PG-100” and “CG-500” (bisphenol AF-type epoxy resin) manufactured by Osaka Gas Chemicals Co., Ltd.; “YL7760” (bisphenol AF-type epoxy resin), “YL7800” (fluorene-type epoxy resin), “jER1010” (solid bisphenol A-type epoxy resin), and “jER1031S” (tetraphenylethane-type epoxy resin) manufactured by Mitsubishi Chemical Corporation; and the like.

As the epoxy resin, in addition to the above epoxy resins, EPOCHALIC series “THI-DE”, “DE-102”, and “DE-103” (alicyclic epoxy compound) manufactured by ENEOS Corporation, the epoxy compounds described in JP2020-172574A, and the like can also be used.

The epoxy equivalent of the epoxy resin is preferably 50 to 5,000 g/eq., more preferably 50 to 3,000 g/eq., even more preferably 60 to 2,000 g/eq., particularly preferably 70 to 1,000 g/eq., and most preferably 100 to 500 g/eq. The epoxy equivalent means the mass of a resin containing 1 equivalent of epoxy groups, and can be measured according to JIS K7236.

The lower limit of the viscosity of the epoxy resin is preferably 500 mPa·s or more. The upper limit thereof is not particularly limited. For example, the upper limit is 100 Pas or less, preferably 5,000 mPa·s or less, more preferably 4,000 mPa·s or less, and even more preferably 3,000 mPa·s or less. The viscosity of the epoxy resin is a value measured using an E-type viscometer at 25±2° C.

The lower limit of the weight-average molecular weight of the epoxy resin is preferably 100 or more, more preferably 250 or more, and even more preferably 400 or more. The upper limit thereof is preferably 5,000 or less, more preferably 3,000 or less, and even more preferably 1,500 or less.

One epoxy resin may be used alone, or two or more epoxy resins may be used in combination.

The lower limit of the content of the epoxy resin (total content in a case where the composition contains a plurality of epoxy resins) with respect to the total solid content in the composition is preferably 3% by mass or more, and more preferably 5% by mass or more. In addition, the upper limit thereof with respect to the total solid content in the composition is preferably 20% by mass or less, and more preferably 15% by mass or less.

The lower limit of the content of the epoxy resin (total content in a case where the composition contains a plurality of epoxy resins) with respect to the total mass of the composition is preferably 3% by mass or more, and more preferably 5% by mass or more. In addition, the upper limit thereof with respect to the total mass of the composition is preferably 20% by mass or less, and more preferably 15% by mass or less.

[Reactive Diluent]

The composition may contain a reactive diluent.

Containing large amounts of the specific magnetic particles, usually, the composition has high viscosity. In a case where the composition contains a reactive diluent, the viscosity of the composition can be lowered, which further improves the embedding suitability of the composition.

The reactive diluent is a compound having a reactive group. Examples of the reactive group include an epoxy group, an acryloyl group, a methacryloyl group, an oxetane group, and the like. Among these, an epoxy group is preferable as the reactive group.

The reactive diluent containing an epoxy group does not include compounds corresponding to the epoxy resins described above.

The number of reactive groups in the reactive diluent is not particularly limited, and is, for example, 1 or more, and more preferably 2 or more. The upper limit thereof is not particularly limited, and is, for example, 10 or less, and preferably 6 or less.

The viscosity of the reactive diluent is preferably 1 mPa·s or more and less than 500 mPa·s, more preferably 5 mPa·s or more and less than 500 mPa·s, and even more preferably 10 mPa·s or more and less than 500 mPa·s. The viscosity of the reactive diluent can be measured by the same method as the method of measuring viscosity of the epoxy resin described above.

Examples of commercially available products of the reactive diluent include “EX-201” (cyclic aliphatic glycidyl ether), “EX-830” and “EX-821” (ethylene glycol-type epoxy resin), “EX-212” (a hexanediol-type epoxy resin), and “ZX-1658” and “ZX-1658GS” (liquid 1,4-glycidylcyclohexane) manufactured by NIPPON STEEL Chemical & Material Co., Ltd.; “EP-3980S” (glycidylamine-type epoxy resin), “EP-4088S” and “EP-4088L” (dicyclopentadiene-type epoxy resin), “ED-523T” (neopentyl glycol glycidyl ether), and “ED-509S” (tert-butylphenyl glycidyl ether) manufactured by ADEKA CORPORATION; “X-22-163” (siloxane-type epoxy resin) manufactured by Shin-Etsu Chemical Co., Ltd.; and the like.

As the reactive diluent, in addition to the above reactive diluents, EPOCHALIC series “THI-DE”, “DE-102”, and “DE-103” (alicyclic epoxy compounds) manufactured by ENEOS Corporation and the epoxy compounds described in JP2020-172574A can also be used.

In a case where the reactive diluent has an epoxy group, the epoxy equivalent of the reactive diluent is preferably 50 to 5,000 g/eq., more preferably 50 to 3,000 g/eq., even more preferably 60 to 2,000 g/eq., and particularly preferably 70 to 1,000 g/eq.

One reactive diluent may be used alone, or two or more reactive diluents may be used in combination.

In a case where the composition contains a reactive diluent, the lower limit of the content of the reactive diluent (total content in a case where the composition contains a plurality of reactive diluents) with respect to the total solid content in the composition is preferably 1% by mass or more, and more preferably 2% by mass or more. The upper limit thereof is preferably 10% by mass or less, more preferably 8% by mass or less, and even more preferably 5% by mass or less.

In a case where the composition contains a reactive diluent, the lower limit of the content of the reactive diluent (total content in a case where the composition contains a plurality of reactive diluents) with respect to the total mass of the composition is preferably 1% by mass or more, and more preferably 2% by mass or more. The upper limit thereof with respect to the total mass of the composition is preferably 10% by mass or less, more preferably 8% by mass or less, and even more preferably 5% by mass or less.

The ratio of the content of the epoxy resin to the content of the reactive diluent (content of epoxy resin/content of reactive diluent) is preferably 0.05 or more, and more preferably 0.1 or more. The upper limit thereof is not particularly limited, and is, for example, 5 or less, preferably 4 or less, more preferably 3 or less, and even more preferably 2.5 or less

[Curing Agent]

It is preferable that the composition contain a curing agent.

The curing agent is not particularly limited, and examples thereof include a phenol-based curing agent, a naphthol-based curing agent, an acid anhydride-based curing agent, an imidazole-based curing agent, an active ester-based curing agent, a benzoxazine-based curing agent, a cyanate ester-based curing agent, a carbodiimide-based curing agent, and an amine adduct-based curing agent.

Specific examples of the phenol-based curing agent and the naphthol-based curing agent include “MEH-7700”, “MEH-7810”, and “MEH-7851” manufactured by MEIWA PLASTIC INDUSTRIES, LTD., “NHN”, “CBN”, and “GPH” manufactured by Nippon Kayaku Co., Ltd., “SN-170”, “SN-180”, “SN-190”, “SN-475”, “SN-485”, “SN-495”, “SN-375”, and “SN-395” manufactured by NIPPON STEEL Chemical & Material Co., Ltd., “LA-7052”, “LA-7054”, “LA-3018”, “LA-3018-50P”, “LA-1356”, “TD2090”, and “TD-2090-60M” manufactured by DIC Corporation, and the like.

Examples of the acid anhydride-based curing agent include a curing agent having one or more acid anhydride groups in one molecule.

Specific examples of the acid anhydride-based curing agent include phthalic anhydride, tetrahydrophthalic anhydride, hexahydrophthalic anhydride, methyl tetrahydrophthalic anhydride, methyl hexahydrophthalic anhydride, methyl nadic anhydride, hydrogenated methyl nadic anhydride, trialkyltetrahydrophthalic anhydride, dodecenyl succinic anhydride, 5-(2,5-dioxotetrahydro-3-furanyl)-3-methyl-3-cyclohexene-1,2-dicarboxylic anhydride, trimellitic anhydride, pyromellitic anhydride, benzophenone tetracarboxylic dianhydride, biphenyltetracarboxylic acid dianhydride, naphthalene tetracarboxylic dianhydride, oxydiphthalic dianhydride, 3,3′-4,4′-diphenyl sulfone tetracarboxylic dianhydride, 1,3,3a,4,5,9b-hexahydro-5-(tetrahydro-2,5-di oxo-3-furanyl)-naphtho[1,2-C]furan-1,3-dione, ethylene glycol bis(anhydrotrimellitate), a polymer-type acid anhydride such as styrene maleic acid resin formed by copolymerization of styrene and maleic acid, and the like.

Examples of commercially available products of acid anhydride-based curing agents include “HNA-100”, “MH-700”, “MTA-15”, “DDSA”, “HF-08”, and “OSA” manufactured by New Japan Chemical Co., Ltd., “YH306” and “YH307” manufactured by Mitsubishi Chemical Corporation, “H-TMAn” manufactured by MITSUBISHI GAS CHEMICAL COMPANY, INC., “HN-2200”, “HN-2000”, “HN-5500” and “MHAC-P” manufactured by Hitachi Chemical Co., Ltd., and the like.

As the active ester-based curing agent, compounds having three or more ester groups with high reaction activity in one molecule, such as phenol esters, thiophenol esters, N-hydroxyamine esters, and esters of heterocyclic hydroxy compounds, are preferably used.

As the active ester-based curing agent, an active ester compound containing a dicyclopentadiene-type diphenol structure, an active ester compound containing a naphthalene structure, an active ester compound containing acetylated phenol novolac, or an active ester compound containing a benzoylated phenol novolac is preferable. “Dicyclopentadiene-type diphenol structure” represents a divalent structural unit consisting of phenylene-dicyclopentalene-phenylene.

Examples of the imidazole-based curing agent include 2-methylimidazole (trade name; 2MZ), 2-undecylimidazole (trade name; C11-Z), 2-heptadecylimidazole (trade name; C17Z), 1,2-dimethylimidazole (trade name; 1.2DMZ), 2-ethyl-4-methylimidazole (trade name; 2E4MZ), 2-phenylimidazole (trade name; 2PZ), 2-phenyl-4-methylimidazole (trade name; 2P4MZ), 1-benzyl-2-methylimidazole (trade name; 1B2MZ), 1-benzyl-2-phenylimidazole (trade name; 1B2PZ), 1-cyanoethyl-2-methylimidazole (trade name; 2MZ-CN), 1-cyanoethyl-2-undecylimidazole (trade name; C11Z-CN), 1-cyanoethyl-2-phenylimidazolium trimellitate (trade name; 2PZCNS-PW), 2,4-diamino-6-[2′-methylimidazolyl-(1′)]-ethyl-s-triazine (trade name; 2MZ-A), 2,4-diamino-6-[2′-undecylimidazolyl-(1′)]-ethyl-s-triazine (trade name; C11Z-A), 2,4-diamino-6-[2′-ethyl-4′-methylimidazolyl-(1′)]-ethyl-s-triazine (trade name; 2E4MZ-A), 2,4-diamino-6-[2′-methylimidazolyl-(1′)]-ethyl-s-triazine isocyanuric acid adduct (trade name; 2MA-OK), 2-phenyl-4,5-dihydroxymethylimidazole (trade name; 2PHZ-PW), 2-phenyl-4-methyl-5-hydroxymethylimidazole (trade name; 2P4MHZ-PW), 1-cyanoethyl-2-phenylimidazole (trade name; 2PZ-CN), 2,4-diamino-6-[2′-methylimidazolyl-(1′)]-ethyl-s-triazine (trade name; 2MZA-PW), and 2,4-diamino-6-[2′-methylimidazolyl-(1′)]-methyl-s-triazine isocyanuric acid adduct (trade name: 2MA-OK-PW) (all manufactured by SHIKOKU KASEI HOLDINGS CORPORATION.)

Examples of commercially available products of active ester-based curing agents include an active ester compound containing a dicyclopentadiene-type diphenol structure, such as “EXB9451”, “EXB9460”, “EXB9460S”, “HPC-8000”, “HPC-8000H”, “HPC-8000-65T”, “HPC-8000H-65TM”, “EXB-8000L”, and “EXB-8000L-65TM” (manufactured by DIC Corporation); an active ester compound containing a naphthalene structure, such as “EXB9416-70BK” and “EXB-8150-65T” (manufactured by DIC Corporation); an active ester compound containing acetylated phenol novolac, such as “DC808” (manufactured by Mitsubishi Chemical Corporation); an active ester compound containing benzoylated phenol novolac, such as “YLH1026” (manufactured by Mitsubishi Chemical Corporation); an active ester-based curing agent which is acetylated phenol novolac, such as “DC808” (manufactured by Mitsubishi Chemical Corporation); an active ester-based curing agent which is benzoylated phenol novolac, such as “YLH1026” (manufactured by Mitsubishi Chemical Corporation), “YLH1030” (manufactured by Mitsubishi Chemical Corporation), and “YLH1048” (manufactured by Mitsubishi Chemical Corporation); and the like.

Specific examples of the benzoxazine-based curing agent include “JBZ-OP100D” and “ODA-BOZ” manufactured by JFE Chemical Corporation; “HFB2006M” manufactured by Showa High Polymer Co., Ltd., “P-d” and “F-a” manufactured by SHIKOKU CHEMICALS CORPORATION, and the like.

Specific examples of the cyanate ester-based curing agent include “PT30” and “PT60” (both of which are phenol novolac-type polyfunctional cyanate ester resins) manufactured by Lonza Japan Ltd., “BA230”, and “BA230S75” (a prepolymer in which some or all of bisphenol A dicyanate molecules are triazinated and form a trimer), and the like.

Specific examples of the carbodiimide-based curing agent include “V-03” and “V-07” manufactured by Nisshinbo Chemical Inc., and the like.

Examples of commercially available products of amine adduct-type curing agents include PN-23 and PN-50 (both of which are manufactured by Ajinomoto Fine-Techno Co., Inc.) of AJICURE series, and the like.

One curing agent may be used alone, or two or more curing agents may be used in combination.

In a case where the composition contains a curing agent, the content of the curing agent (total content in a case where the composition contains a plurality of curing agents) with respect to the total solid content of the composition is preferably 0.001% to 3% by mass, and more preferably 0.01% to 2% by mass.

In a case where the composition contains a curing agent, the content of the curing agent (total content in a case where the composition contains a plurality of curing agents) with respect to the total mass of the composition is preferably 0.001% to 3% by mass, and more preferably 0.01% to 2% by mass.

[Curing Accelerator]

The curing accelerator is not particularly limited, and examples thereof include triphenylphosphine, methyltributylphosphonium dimethylphosphate, tri sorthotolylphosphine, and a boron trifluoride amine complex. Examples of a commercially available products of phosphate-based curing accelerators include HISHICOLIN PX-4MP (manufactured by Nippon Chemical Industrial CO., LTD.)

Examples of triarylphosphine-based curing accelerators also include the compounds described in paragraph “0052” of JP2004-043405A. Examples of the phosphorus-based curing accelerators in which triphenylborane is added to triarylphosphine include the compounds described in paragraph “0024” of JP2014-005382A.

One curing accelerator may be used alone, or two or more curing accelerators may be used in combination.

In a case where the composition contains a curing accelerator, the content of the curing accelerator (total content in a case where the composition contains a plurality of curing accelerators) with respect to the total solid content of the composition is preferably 0.001% to 3% by mass, and more preferably 0.01% to 2% by mass.

In a case where the composition contains a curing accelerator, the content of the curing accelerator (total content in a case where the composition contains a plurality of curing accelerators) with respect to the total mass of the composition is preferably 0.001% to 3% by mass, and more preferably 0.01% to 2% by mass.

[Dispersant]

It is preferable that the composition further contain a dispersant.

Examples of the dispersant include a phosphoric acid ester-based dispersant such as polyoxyethylene alkyl ether phosphoric acid; an anionic dispersant such as sodium dodecylbenzel sulfonate, sodium laurate, or an ammonium salt of polyoxyethylene alkyl ether sulfate; an organosiloxane-based dispersant; a nonionic dispersant such as acetylene glycol, polyoxyethylene alkyl ether, polyoxyethylene alkyl ester, polyoxyethylene sorbitan fatty acid ester, polyoxyethylene alkyl phenyl ether, polyoxyethylene alkyl amine, or polyoxyethylene alkylamide; and the like. In a case where the dispersant has an epoxy group, the dispersant also includes the aforementioned epoxy resins.

One dispersant may be used alone, or two or more dispersants may be used in combination.

Examples of commercially available products of the phosphoric acid ester-based dispersant include “RS-410”, “RS-610”, and “RS-710” of “PHOSPHANOL” series manufactured by TOHO Chemical Industry Co., Ltd., and the like.

Examples of commercially available products of the organosiloxane-based dispersant include “BYK347” and “BYK348” manufactured by BYK-Chemie GmbH, and the like.

Examples of commercially available products of the polyoxyalkylene-based dispersant include “AKM-0531”, “AFB-1521”, “SC-0505K”, “SC-1015F”, “SC-0708A”, and “HKM-50A” of “MALIALIM” series manufactured by NOF CORPORATION, and the like.

“Polyoxyalkylene-based dispersant” is a generic term for polyoxyethylene alkyl ether, polyoxyethylene alkyl ester, polyoxyethylene sorbitan fatty acid ester, polyoxyethylene alkyl phenyl ether, polyoxyethylene alkyl amine, polyoxyethylene alkylamide, and the like.

Examples of commercially available products of acetylene glycol include “82”, “104”, “440”, “465”, “485”, and “olefin Y” of “SURFYNOL” series manufactured by Air Products and Chemicals Inc., and the like.

One dispersant may be used alone, or two or more dispersants may be used in combination.

In a case where the composition contains a dispersant, the content of the dispersant (total content in a case where the composition contains a plurality of dispersants) with respect to the total solid content of the composition is preferably 0.001% to 3% by mass, and more preferably 0.01% to 2% by mass.

In a case where the composition contains a dispersant, the content of the dispersant (total content in a case where the composition contains a plurality of dispersants) with respect to the total mass of the composition is preferably 0.001% to 3% by mass, and more preferably 0.01% to 2% by mass.

[Solvent]

The composition may contain a solvent.

In a case where the composition contains a solvent, the content of the solvent with respect to the total mass of the composition is preferably 1% by mass or less, more preferably 0.8% by mass or less, and even more preferably 0.5% by mass or less. The lower limit thereof not particularly limited, but is 0.001% by mass or more.

[Other Optional Components]

The composition may further contain other optional components in addition to the aforementioned components. Examples of the optional components include magnetic particles other than the specific magnetic particles, a polymerization initiator, a polymerizable compound other than the reactive diluent, a surfactant, a rheology control agent, resins other than the epoxy resin (for example, an alkali-soluble resin), a sensitizer, a co-sensitizer, a plasticizer, an oil sensitizing agent, a filler, a rubber component, and the like. Furthermore, as necessary, known additives, such as other aids (for example, an antifoaming agent, a flame retardant, a leveling agent, a peeling accelerator, an antioxidant, a fragrance, a surface tension adjuster, a chain transfer agent, and the like) may added.

[Manufacturing Method of Composition]

The composition can be prepared by mixing together the components described above by a known mixing method (for example, a mixing method using a stirrer, a homogenizer, a high-pressure emulsifier, a wet pulverizer, a wet disperser, or the like).

In preparing the composition, the components may be mixed together at once, or the components may be dissolved or dispersed one by one in a solvent and then sequentially mixed together. Furthermore, the order of adding components and working conditions at the time of mixing are not particularly limited. For example, in a case where two or more other resins are used, the resins may be mixed together at once, or each kind of resin may be mixed in batches.

[Use]

The composition can be suitably used as a composition for filling holes of hole portions, such as via holes and through-holes, provided on a circuit board. One of the examples of the specific procedure for filling holes is a method including the following steps 1 to 3.

Step 1: a step of coating a substrate provided with hole portions such as via holes or through-holes with the composition by a known coating method such as a slit coating method, an ink jet method, a spin coating method, a cast coating method, a roll coating method or a screen printing method such that the hole portions are filled with the composition.

Step 2: a step of heating the composition on the substrate having undergone the step 1 at about 120° C. to 180° C. for about 30 to 90 minutes such that thermally curable components (for example, the epoxy resin, the reactive diluent, and the like) in the composition are cured.

Step 3: a step of removing unnecessary portions of the magnetic particle-containing cured substance obtained through the step 2 protruding from the substrate surface by physical polishing to make a flat surface.

The circuit board containing the magnetic particle-containing cured substance is suitably used, for example, as electronic components such as an antenna and an inductor to be installed in an electronic communication device or the like.

It is also preferable that the composition be formed into a film.

In view of further improving magnetic permeability, the film thickness of the film formed of the composition is preferably 1 to 10,000 μm, more preferably 10 to 1,000 μm, and particularly preferably 15 to 800 μm.

The film formed of the composition is suitably used, for example, as electronic components such as an antenna and an inductor to be installed in an electronic communication device and the like.

[Magnetic Particle-Containing Cured Substance]

The magnetic particle-containing cured substance according to an embodiment of the present invention is a cured substance formed of the aforementioned composition.

The shape of the magnetic particle-containing cured substance of according to the embodiment of the present invention is not particularly limited. For example, as described above, the cured substance may have a shape compatible with the shape of the hole portions provided in the substrate or may have a film shape.

Hitherto, as an example of specific aspects of the manufacturing method of a magnetic particle-containing cured substance, a manufacturing method of a magnetic particle-containing cured substance that may be performed in a case where the composition is used as a composition for filling holes has been described. Hereinafter, as an example of other specific aspects, a manufacturing method of a film-shaped magnetic particle-containing cured substance (hereinafter, also called “magnetic particle-containing film”) will be described.

[Manufacturing Method of Magnetic Particle-Containing Film]

The magnetic particle-containing film is obtained by curing the aforementioned composition.

The manufacturing method of a magnetic particle-containing film is not particularly limited, and is preferably a manufacturing method including the following steps. In a case where the following manufacturing method of a magnetic particle-containing film is carried out, it is also preferable that the composition contain a cationic polymerization initiator that is sensitive to light and/or heat.
Composition layer forming step
Curing step

<Composition Layer Forming Step>

In the composition layer forming step, the composition is applied to a substrate (support) or the like such that a layer of the composition (composition layer) is formed. As the substrate, for example, a wiring board having an antenna portion or an inductor portion and the like can be used.

As a method for applying the composition to the substrate, various coating methods such as a slit coating method, an ink jet method, a spin coating method, a cast coating method, a roll coating method, and a screen printing method can be used. The film thickness of the composition layer is preferably 1 to 10,000 μm, more preferably 10 to 1,000 μm, and even more preferably 15 to 800 μm. The composition layer formed on the substrate by coating may be heated (pre-baked). The pre-baking is performed, for example, using a hot plate, an oven, or the like at a temperature of 50° C. to 140° C. for 10 to 1,800 seconds. Particularly, it is preferable to perform pre-baking in a case where the composition contains a solvent.

<Curing Step>

The curing step is not particularly limited as long as the composition layer can be cured, and examples thereof include a heating treatment of heating the composition layer, an exposure treatment of irradiating the composition layer with an actinic ray or radiation, and the like.

In a case where the heating treatment is performed, for example, the heating treatment can be performed continuously or in batch by using heating means such as a hot plate, a convection oven (hot air circulation-type dryer), or a high-frequency heater.

The heating temperature during the heating treatment is preferably 120° C. to 260° C., and more preferably 150° C. to 240° C. The heating time is not particularly limited, but is preferably 10 to 1,800 seconds.

Note that pre-baking in the composition layer forming step may serve as the heating treatment in the curing step.

In a case where the exposure treatment is performed, the method of irradiating the composition layer with an actinic ray or radiation is not particularly limited. It is preferable to irradiate the composition layer through a photomask having a patterned opening portion.

The exposure is preferably performed by irradiation with radiation. As the radiation that can be used for exposure, an ultraviolet ray such as g-line, h-line, or i-line is preferable, and a high-pressure mercury lamp is preferable as a light source. The irradiation intensity is preferably 5 to 1,500 mJ/cm², and more preferably 10 to 1,000 mJ/cm².

In a case where the composition contains a thermal polymerization initiator, the composition layer may be heated in the above exposure treatment. The heating temperature is not particularly limited, but is preferably 80° C. to 250° C. The heating time is not particularly limited, but is preferably 30 to 300 seconds.

In a case where the composition layer is heated in the exposure treatment, the heating may serve as a post-heating step which will be described later. In other words, in a case where the composition layer is heated in the exposure treatment, the manufacturing method of a magnetic particle-containing film may not include a post-heating step.

<Development Step>

In a case where the exposure treatment is performed in the curing step, the manufacturing method may further include a development step.

The development step is a step of developing the exposed composition layer to form a magnetic particle-containing film. By this step, the composition layer in a portion not being irradiated with light in the exposure treatment is eluted, and only the photo-cured portion remains. In this way, a patterned magnetic particle-containing film is obtained.

Although the type of developer used in the development step is not particularly limited, it is desirable to use an alkali developer that does not damage the circuit or the like.

The development temperature is, for example, 20° C. to 30° C.

The development time is, for example, 20 to 90 seconds. In recent years, in order to more thoroughly remove residues, sometimes the development has been performed for 120 to 180 seconds. Furthermore, in order to further improve the residue removability, sometimes a step of shaking off the developer every 60 seconds and supplying a new developer is repeated several times.

As the alkali developer, an alkaline aqueous solution is preferable which is prepared by dissolving an alkaline compound in water at a concentration of 0.001% to 10% by mass (preferably 0.01% to 5% by mass).

Examples of the alkaline compound include sodium hydroxide, potassium hydroxide, sodium carbonate, sodium silicate, sodium metasilicate, aqueous ammonia, ethylamine, diethylamine, dimethylethanolamine, tetramethylammonium hydroxide, tetraethylammonium hydroxide, tetrapropylammonium hydroxide, tetrabutylammonium hydroxide, benzyltrimethylammonium hydroxide, choline, pyrrole, piperidine, 1,8-diazabicyclo[5.4.0]-7-undecene, and the like (among these, an organic alkali is preferable).

In a case where an alkali developer is used, generally, a rinsing treatment using water is performed after development.

<Post-Baking>

In a case where the exposure treatment is performed in the curing step, it is preferable to perform the heating treatment (post-baking) after the curing step. The post-baking is a heating treatment for completion of curing. In a case where the development step is performed, it is preferable to perform the post-baking after the development step. The heating temperature is preferably 240° C. or lower, and more preferably 220° C. or lower. The lower limit of the heating temperature is not particularly limited. However, considering an efficient and effective treatment, the heating temperature is preferably 50° C. or higher, and more preferably 100° C. or higher. The heating time is not particularly limited, but is preferably 10 to 1,800 seconds.

The post-baking can be performed continuously or in batch by using heating means such as a hot plate, a convection oven (hot air circulation-type dryer), or a high-frequency heater.

It is preferable that the aforementioned post-baking be performed in an atmosphere with a low oxygen concentration. The oxygen concentration is preferably 19% by volume or less, more preferably 15% by volume or less, even more preferably 10% by volume or less, particularly preferably 7% by volume or less, and most preferably 3% by volume or less. The lower limit of the oxygen concentration is not particularly limited, but is practically 10 ppm by volume or more.

[Electronic Component]

The electronic component according to an embodiment of the present invention includes the aforementioned magnetic particle-containing cured substance. That is, the electronic component according to the embodiment of the present invention may include the magnetic particle-containing cured substance as a part of the component. Examples of electronic component include an inductor and an antenna. As the electronic component, an electronic component having a known structure can be used.

### EXAMPLES

Hereinafter, the present invention will be more specifically described based on examples. The materials, amounts and proportions of the materials used, details and procedures of treatments, and the like described in the following examples can be appropriately changed as long as the gist of the present invention is maintained. Therefore, the scope of the present invention is not limited to the following specific examples.

In the following description, unless otherwise specified, “%” means “% by mass”, and “parts” means “parts by mass”.

[Various Components Used for Preparing Composition]

To make the composition, the components described in the following table were prepared. The components described in the following table are summarized below.

[Magnetic Particles]

As the magnetic particles, P-1 to P-4 and CP-1 to CP-4 shown below were used.
P-1: trade name “KUAMET NC1” (manufactured by Epson Atmix Corporation) “Fe nanocrystalline alloy, Fe atom content: 83% by mass, D50: 16 μm, concentration of solid contents: 100% by mass”
P-2: trade name “KUAMET NC1” (manufactured by Epson Atmix Corporation) “Fe nanocrystalline alloy, Fe atom content: 83% by mass, D50: 23 μm concentration of solid contents: 100% by mass”
P-3: trade name “KUAMET6B2-53 μm” (manufactured by Epson Atmix Corporation) “Fe group amorphous, Fe atom content: 87% by mass, D50: 24 μm concentration of solid contents: 100% by mass”
P-4: trade name “EA-SMP-10 PF-20F” (manufactured by Epson Atmix Corporation) “FeSiCr alloy, Fe atom content: 92% by mass, D50: 10 μm concentration of solid contents: 100% by mass”
CP-1: Fe—Mn-based ferrite manufactured by Powdertech. “Fe—Mn-based ferrite, D50: 3 μm concentration of solid contents: 100% by mass”
CP-2: Fe—Mn-based ferrite manufactured by Powdertech. “Fe—Mn-based ferrite, D50: 0.2 μm concentration of solid contents: 100% by mass”
CP-3: trade name “AW2-08 PF3F (manufactured by Epson Atmix Corporation) “Fe group amorphous, Fe atom content: 87% by mass, D50: 3 μm concentration of solid contents: 100% by mass”
CP-4: trade name “KUAMET6B2-150 μm (manufactured by Epson Atmix Corporation) “Fe group amorphous, Fe atom content: 87% by mass, D50: 50 μm, concentration of solid contents: 100% by mass”

[Resin]

<Epoxy Resin>
D-1: trade name “ZX-1059” (manufactured by NIPPON STEEL Chemical & Material Co., Ltd.) “liquid epoxy resin (mixture of bisphenol A-type epoxy resin and bisphenol F-type epoxy resin), concentration of solid contents: 100% by mass”
D-3: trade name “EPICLON N-695” (manufactured by DIC Corporation) “cresol novolac-type epoxy resin, concentration of solid contents: 100% by mass”
D-4: trade name “EHPE 3150” (manufactured by Daicel Corporation) “alicyclic epoxy resin, concentration of solid contents: 100% by mass”

<Dispersant>
D-2: trade name “RS-710” (manufactured by TOHO Chemical Industry Co., Ltd.) “phosphoric acid ester-based dispersant, concentration of solid contents: 100% by mass”

[Curing Agent]
A-1: trade name “2MZA-PW” (manufactured by imidazole-based curing accelerator, manufactured by SHIKOKU KASEI HOLDINGS CORPORATION, concentration of solid contents: 100% by mass”
A-2: trade name “LA-7054” (manufactured by DIC Corporation) “triazine skeleton-containing phenol-based curing agent, concentration of solid contents: 100% by mass”

[Reactive Diluent]
C-1: trade name “ZX-1658GS” (manufactured by NIPPON STEEL Chemical & Material Co., Ltd.) “cyclic aliphatic diglycidyl ether, concentration of solid contents: 100% by mass”
C-2: trade name “EX-201” (manufactured by Nagase ChemteX Corporation.) “resorcinol diglycidyl ether, concentration of solid contents: 100% by mass”
C-3: trade name “ED-523T” (manufactured by ADEKA CORPORATION)) “low-viscosity epoxy resin, concentration of solid contents: 100% by mass”

### Preparation of Compositions of Examples and Comparative Examples

The components shown in the following table were mixed together and uniformly dispersed in a roll mill, thereby preparing compositions of examples and comparative examples.

[Various Measurements and Evaluations]

[Measurement]

<Measurement of Peak Tops Dₘₐₓ and Dₘᵢₙ>

For the composition of each of examples and comparative examples, a particle size distribution curve showing a volume-based frequency distribution was created based on the method described above, and Dₘₐₓ (μm), Dₘᵢₙ (μm), Dₘₐₓ/Dₘᵢₙ of the magnetic particles contained in the composition of each of examples and comparative examples are determined.

In a case where the particle size distribution curve showing a volume-based frequency distribution has one peak top, the particle diameter that appears at the peak top is listed as Dₘₐₓ in the following table.

[Evaluation]

<Evaluation of Magnetic Performance (Magnetic Permeability and Magnetic Loss)>

By using an applicator, a Si wafer having a thickness of 100 μm was coated with each of the compositions of examples and comparative examples such that a film having a thickness of 100 μm was formed. In this way, a coating film was formed.

Next, the wafer was dried and heated under drying conditions of 100° C. for 10 minutes and then further heated at 230° C. for 10 minutes, thereby preparing a substrate with a cured film.

Subsequently, the obtained substrate with a cured film was cut into substrates each having a size of 1 cm×2.8 cm, and by using PER-01 (manufactured by KEYCOM Corp., high-frequency magnetic permeability measuring device), the magnetic permeability at 50 MHz of the cured film in each of the obtained sample substrates for measurement was measured, thereby obtaining complex permeability μ′ (real part) and μ″ (imaginary part) of the cured film.

Furthermore, a magnetic loss (tan δ) was calculated by the following Equation (1).

tan δ=μ″/μ′ Equation (1):

Based on the obtained value of the specific magnetic permeability μ′, evaluation was performed according to the following evaluation standard, and the result was adopted as an evaluation result of magnetic permeability. For practical use, it is preferable that the specific magnetic permeability μ′ be graded B or higher in the evaluation.

(Evaluation Standard for Specific Magnetic Permeability μ′)
“A”: 10≤μ
“B”: 5≤μ<10
“C”: μ′<5

In addition, based on the obtained value of magnetic loss (tan δ), evaluation was performed according to the following evaluation standard. It is preferable that the evaluation result of the magnetic loss (tan δ) be “B” or higher for practical use.

(Evaluation Standard for Magnetic Loss (Tan δ))
“A”: tan δ≤0.1
“B”: 0.1<tan δ≤0.25
“C”: 0.25<tan δ

<Evaluation of Embedding Suitability>

An FR-4 substrate having a thickness of 0.8 mm was prepared, and through-holes having a diameter of 0.4 mm were formed.

Then, by using DP-320 (NEWLONG SEIMITSU KOGYO Co., LTD.), the substrate was treated such that each of the compositions of examples and comparative examples was embedded in the through-holes. Thereafter, the obtained substrate in which the composition was embedded was heated at 160° C. for 1 hour such that the composition was cured.

The obtained substrate was subjected to a polishing treatment such that the cross section of the embedded portion was exposed, and the state of the interior of the substrate was observed with a scanning electron microscope (SEM).

An image was obtained at n=30, and the proportion of openings calculated by Image J was averaged and adopted as an index of embedding suitability. Based on the value (Va) obtained by averaging and the following evaluation standard, filling suitability was evaluated. The smaller the value of Va, the fewer the openings caused by voids, cracks, and the like in the cured substance, which is preferable. It is preferable that the evaluation result of embedding suitability be “B” or higher for practical use.

(Evaluation Standard for Embedding Suitability)
“A”: Va<5%
“B”: 5%≤Va<15%
“C”: 15%≤Va

The following table shows the formulation of each composition and the results of evaluation tests performed on each composition.

In a case where the particle size distribution curve showing a volume-based frequency distribution has one peak top, the particle diameter that appears at the peak top is listed as Dₘₐₓ in the following table.

TABLE 1

| | Formulation of composition | | | | | | | | |
|---|---|---|---|---|---|---|---|---|---|
| | Magnetic | | | | | | | | |
| | particles | | Epoxy resin | | Dispersant | | Curing agent | | |
| | | Content | | Content | | Content | | Content | Reactive |
| | | (% by | | (% by | | (% by | | (% by | diluent |
| | Type | mass) | Type | mass | Type | mass) | Type | mass) | Type |
| Example 1 | P-1 | 86 | D-1 | 8 | D-2 | 1 | A-1 | 1 | C-1 |
| Example 2 | P-2 | 86 | D-1 | 8 | D-2 | 1 | A-1 | 1 | C-1 |
| Example 3 | P-3 | 86 | D-1 | 8 | D-2 | 1 | A-1 | 1 | C-1 |
| Example 4 | P-4 | 86 | D-1 | 8 | D-2 | 1 | A-1 | 1 | C-1 |
| Example 5 | P-1 | 43 | D-1 | 8 | D-2 | 1 | A-1 | 1 | C-1 |
| | CP-3 | 43 | | | | | | | |
| Example 6 | P-3 | 43 | D-1 | 8 | D-2 | 1 | A-1 | 1 | C-1 |
| | CP-3 | 43 | | | | | | | |
| Example 7 | P-1 | 43 | D-1 | 8 | D-2 | 1 | A-1 | 1 | C-1 |
| | P-4 | 43 | | | | | | | |
| Example 8 | P-1 | 86 | D-3 | 8 | D-2 | 1 | A-1 | 1 | C-1 |
| Example 9 | P-1 | 86 | D-4 | 8 | D-2 | 1 | A-1 | 1 | C-1 |
| Example 10 | P-1 | 86 | D-1 | 8 | D-2 | 1 | A-2 | 1 | C-1 |
| Example 11 | P-1 | 86 | D-1 | 8 | D-2 | 1 | A-1 | 1 | C-2 |
| Example 12 | P-1 | 86 | D-1 | 8 | D-2 | 1 | A-1 | 1 | C-3 |
| Example 13 | P-1 | 72 | D-1 | 18 | D-2 | 2 | A-1 | 2 | C-1 |
| Comparative | CP-1 | 86 | D-1 | 8 | D-2 | 1 | A-1 | 1 | C-1 |
| Example 1 | | | | | | | | | |
| Comparative | CP-2 | 86 | D-1 | 8 | D-2 | 1 | A-1 | 1 | C-1 |
| Example 2 | | | | | | | | | |
| Comparative | CP-3 | 86 | D-1 | 8 | D-2 | 1 | A-1 | 1 | C-1 |
| Example 3 | | | | | | | | | |
| Comparative | CP-4 | 86 | D-1 | 8 | D-2 | 1 | A-1 | 1 | C-1 |
| Example 4 | | | | | | | | | |
| Comparative | P-1 | 66 | D-1 | 22 | D-2 | 2 | A-1 | 2 | C-1 |
| Example 5 | | | | | | | | | |
| Comparative | P-1 | 93 | D-1 | 4 | D-2 | 1 | A-1 | 1 | C-1 |
| Example 6 | | | | | | | | | |
| | | Formulation | | | | | | | |
| | | of | Evaluation | | | | | | |
| | | composition | Peak particle diameter | | | | | | |
| | | Reactive | in particle size | | | | | | |
| | | diluent | distribution curve | | | | | | |
| | | Content | | | | Number | Magnetic | Magnetic | |
| | | (% by | Dₘₐₓ | Dₘᵢₙ | Dₘₐₓ/ | of peak | permeability | loss | Embedding |
| | | mass) | (μm) | (μm) | Dₘᵢₙ | tops | μ′ | tanδ | suitability |
| | Example 1 | 4 | 16 | — | — | 1 | A | A | A |
| | Example 2 | 4 | 23 | — | — | 1 | A | B | A |
| | Example 3 | 4 | 24 | — | — | 1 | A | B | A |
| | Example 4 | 4 | 10 | — | — | 1 | B | A | A |
| | Example 5 | 4 | 16 | 3 | 5.3 | 2 | A | A | A |
| | Example 6 | 4 | 24 | 3 | 8 | 2 | A | A | A |
| | Example 7 | 4 | 16 | 10 | 1.6 | 2 | B | A | A |
| | Example 8 | 4 | 16 | — | — | 1 | A | A | A |
| | Example 9 | 4 | 16 | — | — | 1 | A | A | A |
| | Example 10 | 4 | 16 | — | — | 1 | A | A | A |
| | Example 11 | 4 | 16 | — | — | 1 | A | A | A |
| | Example 12 | 4 | 16 | — | — | 1 | A | A | A |
| | Example 13 | 6 | 16 | — | — | 1 | B | A | A |
| | Comparative | 4 | 3 | — | — | 1 | C | A | A |
| | Example 1 | | | | | | | | |
| | Comparative | 4 | 0.2 | — | — | 1 | C | A | A |
| | Example 2 | | | — | — | | | | |
| | Comparative | 4 | 3 | — | — | 1 | C | A | A |
| | Example 3 | | | — | — | | | | |
| | Comparative | 4 | 50 | — | — | 1 | A | C | B |
| | Example 4 | | | — | — | | | | |
| | Comparative | 8 | 16 | — | — | 1 | C | A | A |
| | Example 5 | | | — | — | | | | |
| | Comparative | 1 | 16 | — | — | 1 | A | B | C |
| | Example 6 | | | | | | | | |

From the results in the above table, it has been revealed that a cured substance having a high magnetic permeability and a low magnetic loss is obtained from the compositions of examples. In addition, it has been revealed that the compositions of examples have excellent embedding suitability.

By the comparison of Examples 1 to 4, it has been confirmed that the magnetic loss is further reduced in a case where the specific magnetic particles in the composition have a peak top at 10 to 20 μm in the particle size distribution curve showing a volume-based frequency distribution.

By the comparison of Examples 1 to 4, it has been also confirmed that the magnetic permeability is increased in a case where the specific magnetic particles in the composition have a peak top in a range of 12 to 30 μm in the particle size distribution curve showing a volume-based frequency distribution.

By the composition of Examples 1, 3, 5, and 6, it has been also confirmed that the magnetic loss is further reduced in a case where the specific magnetic particles in the composition have Dₘₐₓ in a range of 10 to 30 μm and Dₘᵢₙ, in a range of 1 to 9 μm in the particle size distribution curve showing a volume-based frequency distribution.

By the comparison between Examples 5 and 7, it has been also confirmed that the magnetic permeability is further increased in a case where Dₘₐₓ/Dₘᵢₙ of the specific magnetic particles in the composition is 2 or more in the particle size distribution curve showing a volume-based frequency distribution.

By the comparison between Examples 1 and 13, it has been confirmed that the magnetic permeability is further increased in a case where the content of the specific magnetic particles is 75% to 90% by mass.

On the other hand, the desired effects are not obtained from the compositions of comparative examples.

### EXPLANATION OF REFERENCES

P, Pₘᵢₙ, Pₘₐₓ peak top
Dₘᵢₙ, Dₘₐₓ particle diameter

What is claimed is:

1. A composition comprising:
magnetic particles that have an Fe atom content of 70% by mass or more; and
an epoxy resin,
wherein the magnetic particles have a peak top in a range of 10 to 30 μm in a particle size distribution curve showing a volume-based frequency distribution, and
a content of the magnetic particles is 70% to 90% by mass with respect to a total solid content in the composition.

2. The composition according to claim 1,
wherein the magnetic particles have an Fe atom content of 70% to 95% by mass.

3. The composition according to claim 1,
wherein the magnetic particles have a plurality of peak tops in the particle size distribution curve showing a volume-based frequency distribution, and
in a case where Dₘᵢₙ represents a particle diameter at a peak top Pₘᵢₙ where the particle diameter is minimized among the plurality of peak tops and Dₘₐₓ represents a particle diameter at a peak top Pmax where the particle diameter is maximized among the plurality of peak tops, Dₘₐₓ/Dₘᵢₙ is 2 or more.

4. The composition according to claim 3,
wherein the Dₘₐₓ is in a range of 10 to 30 μm, and
the Dₘᵢₙ is in a range of 1 to 9 μm.

5. The composition according to claim 1, further comprising:
a reactive diluent.

6. The composition according to claim 1, further comprising:
a curing agent.

7. A magnetic particle-containing cured substance formed of the composition according to claim 1.

8. An electronic component comprising:
the magnetic particle-containing cured substance according to claim 7.

9. The electronic component according to claim 8,
wherein the electronic component is used as an inductor.

10. The electronic component according to claim 8,
wherein the electronic component is used as an antenna.

11. The composition according to claim 2,
wherein the magnetic particles have a plurality of peak tops in the particle size distribution curve showing a volume-based frequency distribution, and
in a case where Dₘᵢₙ represents a particle diameter at a peak top Pₘᵢₙ where the particle diameter is minimized among the plurality of peak tops and Dₘₐₓ represents a particle diameter at a peak top Pₘₐₓ where the particle diameter is maximized among the plurality of peak tops, Dₘₐₓ/Dₘᵢₙ is 2 or more.

12. The composition according to claim 11,
wherein the Dₘₐₓ is in a range of 10 to 30 μm, and
the Dₘᵢₙ is in a range of 1 to 9 μm.

13. The composition according to claim 2, further comprising:
a reactive diluent.

14. The composition according to claim 2, further comprising:
a curing agent.

15. A magnetic particle-containing cured substance formed of the composition according to claim 2.

16. An electronic component comprising:
the magnetic particle-containing cured substance according to claim 15.

17. The electronic component according to claim 16,
wherein the electronic component is used as an inductor.

18. The electronic component according to claim 16,
wherein the electronic component is used as an antenna.

19. The composition according to claim 3, further comprising:
a reactive diluent.

20. The composition according to claim 3, further comprising:
a curing agent.
